(19) United States
(12) Patent Application Publication
(10) Pub. No.: US 2010/0155161 A1
(43) Pub. Date: Jun. 24, 2010

(54) Turbine-based power-generating system for hybrid and electric automobiles, cars, transports, machinery and motorcycles

(76) Inventor: Martin Eugenio Corradini, Mar Del Plata (AR)

Correspondence Address: LOWE HAUPTMAN HAM & BERNER, LLP;Suite 310, 1700 Diagonal Road, Alexandria, VA, 22314, US

(21) Appl. No.: 12/320,839

(22) Filed: Feb. 5, 2009

(30) Foreign Application Priority Data
Oct. 15, 2008 (UY) 31.396

(51) Int. Cl. B60K 6/42; B60K 1/00

(52) U.S. Cl. 180/65.22; 180/65.31; 180/65.21

(57) ABSTRACT

Power-generating system based on turbines activated by gears, driving belts or chains, geared or connected according to design and needs to axles, semi-axles, transmission and differential (also applicable to the flywheel, wheels and gearbox gears). In electric engines only, the system is applicable to rotors, axles and bushings. The rotational movement of the gears, driving belts or chains is transferred to the turbine, which converts it into energy. In the case of motorcycles, the system is activated by driving chains or belts, generating power from the rotational movement of the wheels to the turbine. The system is applicable to hybrid and electric vehicles.

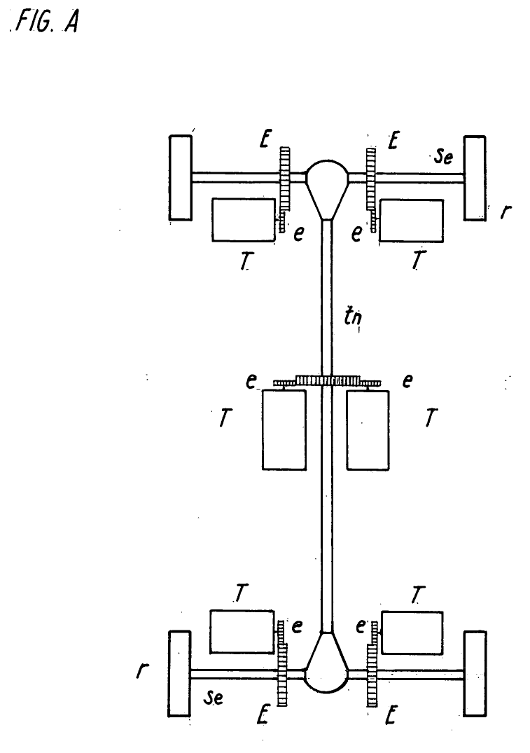

### BACKGROUND

Current power-generating systems for hybrid or electric vehicles are characterized by the use of energy stored in batteries, which need recharging on a daily basis. Therefore, these systems are limited in terms of autonomy and performance.

Never before have power-generating turbines been used to convert the movement of axles, semi-axles, transmission and differential (also applicable to flywheel, wheels and gearbox gears) into electric power for automobiles, cars, transports, machinery, and motorcycles. In electric engines only, the system is applicable to rotors, axles and bushings.

### BRIEF DESCRIPTION OF THE FIGURES OF THE DRAWING

FIG. A. Superior view
T. Turbine
E. Main gear
e. Turbine gear
Se. Semi-axles
Tn. Transmission
r. Wheels

### DETAILED DESCRIPTION OF THE INVENTION

The system is absolutely innovating. It supplies the vehicle with constant power while it is in motion (the more the vehicles circulates, the more power the system generates).

Unlike the system used in existing electric-powered vehicles, the system requires no recharging from external power sources other than an initial charge needed to start the engine and travel a few meters. Then the turbines will generate the power needed for both its functioning and the charging of the batteries.

The system does not need recharging since it generates power for both its overall functioning and batteries, thus providing unlimited autonomy to the vehicle.

No existing turbine, transformer, gear, or driving chain or belt design (corresponding to independent invention patent applications) is adequate to be used with this system. The implementation of the system will require the creation of new designs for these parts of the engine, as well as for the different elements of the chassis, suspension, turbine casing, axles, semi-axles, transmission, differential, etc.

Turbine-based power-generating system activated by gears, driving chains or belts (conversion of mechanical energy into electrical energy) geared or connected according to design and needs to: axles, semi-axles, transmission and differential (also applicable to the flywheel, wheels and gearbox gears). In electric engines only, the system is applicable to rotors, axles and bushings.

In the case of motorcycles, the system is activated by driving chains or belts, generating power from the wheels (rear, front or both) to the turbine. In the case of sidecar motorcycles, the turbine is sitting on the sidecar axle.

The drawing has been simplified for a better understanding of the system. Chassis, suspensions, steering, etc. have been omitted for a better display of key components of the system.

Given the multiple applications of the system, differential and wheels have been simplified for its better understanding. Corresponding to independent invention patent applications, the turbine design has also been simplified.

Turbines are activated by gears, driving belts, or chains, which are geared or connected according to design and needs to: axles, semi-axles, transmission and differential (also applicable to the flywheel, wheels and gearbox gears), converting mechanical energy into electrical energy. In electric engines only, the system is applicable to rotors, axles and bushings.

Requiring no refueling whatsoever, the system will allow for supplying the vehicle with unlimited power. The system produces no polluting emissions and it does not require any fuel.

The system is absolutely innovating. Never before has a turbine-based power-generating system been used. According to design and needs, turbines are activated by the rotational movement of axles, semi-axles, differential and transmission (in hybrid vehicles, also applicable to the flywheel, wheels and gearbox gears; in electric vehicles, also applicable to rotors, axles and bushings).

Turbines are activated by gears, driving belts or chains, which are geared or connected according to design and needs to: axles, semi-axles, transmission and differential (in hybrid vehicles, also applicable to the flywheel, wheels and gearbox gears; in electric vehicles, also applicable to rotors, axles and bushings).

No existing turbine, transformer or gear design (corresponding to independent invention patent applications) is adequate to be used with this system. The implementation of the system will require the creation of new designs for these parts of the engine, as well as for the different elements of the chassis, suspension, axles, semi-axles, differential, transmission, turbine housing, etc.

This system requires no recharging from external power sources other than an initial charged needed to start the engine and travel a few meters. Then the turbines will generate the power needed for both its functioning and the charging of the batteries.

This system is applicable to any kind of hybrid or electricity powered motorcycle, sidecar motorcycle, automobile, car or transport (trucks, pick-up trucks, locomotive, underground locomotive, trams, buses, minibuses, small vehicles, heavy machinery, agricultural machinery, common use machines, war machinery, caterpillar vehicles, etc.).

1. A turbine-based power-generating system for vehicles comprising:
at least one generating turbine installed in a vehicle, the turbine coupled with a rotationally moveable portion of the vehicle.

2. The system as claimed in claim 1, wherein the generating turbines installed in hybrid vehicles are coupled with one or more flywheel, wheels and gearbox gears.

3. The system as claimed in claim 1, wherein the generating turbines installed in electric vehicles are coupled with one or more rotors, axles and bushings.

4. The power-generating system as claimed in claim 1, comprising the connection of one or more of a gear, a driving belt or a chain to one or more axle, semi-axle, transmission or differential.

5. The power-generating system as claimed in claim 1, comprising one or more transmission axles connecting a front axle with a rear axle, in a vehicle, aimed to obtain greater rotational movement and power by allowance of a greater number of turbines.

6. The power-generating system as claimed in claim 1, comprising multiple designs and turbine random distribution including at least one of perpendicular, parallel, superior, inferior turbine placement as regards axles, semi-axles, transmission and differential.

7. The power-generating system as claimed in claim 1, comprising one or more connecting components between turbines and rotational elements.

8. The power-generating system as claimed in claim 1, to the vehicle comprising caterpillar vehicles, machinery, and common-use machines.

9. The power-generating system as claimed in claim 1, to the vehicle comprising one or more amphibious vehicles.

10. The power-generating system as claimed in claim 1, comprising multiple designs and turbine random distribution including at least one of perpendicular, parallel, superior, or inferior turbine placement in relation to one or more of an axle, a semi-axle, a transmission or a differential of a hybrid vehicle.

11. The system as claimed in claim 10, further comprising turbine placement on one or more of a flywheel, one or more wheels or one or more gearbox gears.

12. The power-generating system as claimed in claim 1, comprising multiple designs and turbine random distribution including at least one of perpendicular, parallel, superior, inferior turbine placement on one or more of an axle, a semi-axle, a transmission or a differential in an electric vehicle.

13. The system as claimed in claim 12, further comprising turbine placement on one or more of a rotor, an axle or a bushing.

14. The system as claimed in claim 1, wherein the at least one generating turbine compromises:
one or more generating turbines coupled with one or more axle, semi-axle, transmission, or differential of the vehicle for the conversion of the rotational movement of the one or more axle, semi-axle, transmission, or differential into energy.

15. A method of power generation for a vehicle comprising:
installing at least one generating turbine in a vehicle comprising:
coupling the turbine with a rotationally moveable portion of the vehicle; and
generating power by operating the vehicle to cause rotation of the rotationally moveable portion of the vehicle.
